(19) United States
(12) Patent Application Publication
(10) Pub. No.: US 2004/0155464 A1
(43) Pub. Date: Aug. 12, 2004

(54) Coupling for connection of a tube or hose by pushing-in

(76) Inventor: Tore Slattsveen, Raufoss (NO)

Correspondence Address: Henry C Query Jr, 504 S Pierce Avenue, Wheaton, IL, 60187, US

(21) Appl. No.: 10/469,825

(22) PCT Filed: Mar. 4, 2002
(86) PCT No.: PCT/NO02/00087

(30) Foreign Application Priority Data
Mar. 5, 2001 (NO) 2001 1127

(51) Int. Cl. F16L 17/00

(52) U.S. Cl. 285/322; 285/340

(57) ABSTRACT

A coupling for connection of a tube or hose by pushing-in, comprising a coupling housing formed by two parts (1, 2) which are screwed together or of a single part, said coupling housing containing a clamping ring (6) and a sealing ring (5), for instance an O-ring, where at least the clamping ring is in engagement with an inner conical surface (9) in the coupling housing. A return ring (3) is provided in the coupling, inside of the clamping ring (6) in the direction of insertion of the tube or hose, said return ring engaging, with a conical surface, an inner conical surface (8) in the coupling, oppositely tapered relatively to the conical surface (9) against which the clamping ring (6) is in engagement, and the return ring (3) has a central aperture which is smaller than the external dimension of the tube or hose, and it is expandable, in order to be expanded when the tube or hose is forced through the return ring (3), whereby the engagement against the conical surface (8) will force the return ring (3) to move along the conical surface (8) and thereby also axially, and directly or indirectly, press against the clamping ring (6) in order to force it in the direction of taper of the corresponding conical surface (9).

### FIELD OF THE INVENTION

The invention relates to a coupling for connection of a tube or hose by pushing-in, comprising a coupling housing formed by two parts which are screwed together or of a single part, said coupling housing containing a clamping ring and a sealing ring, for instance an O-ring, where at least the clamping ring is in engagement with an inner conical surface in the coupling housing. The clamping ring may be split.

When the part being inserted in the following is called “tube”, this may also mean “hose”.

### PRIOR ART

A tube coupling of the above mentioned type is known from NO Patent 149598. The coupling housing consists of two housing parts, whereby the clamping ring and the adjacent gasket may be placed between the housing parts prior to connecting these by means of a threaded connection. Oppositely of the clamping ring, seen relatively to the direction of insertion of the tube, the gasket abuts an end surface on one of the housing parts. In order to assure that the clamping ring, upon the connecting, may retain the tube in the coupling housing, the cavity in the other housing part has a tapering or conical portion which the clamping ring abuts. The clamping ring has been given a suitable cross sectional shape which, in cooperation with said tapering portion, provides that the tube is retained if, upon the connecting, an attempt is made to withdraw the tube from the coupling housing.

During insertion of a tube in such a coupling the tube is forced through the clamping ring and the O-ring, and is usually moved into end abutment against a step in the coupling. The insertion causes that the clamping ring and the O-ring are brought somewhat along by the tube, whereby the clamping ring and the O-ring are moved somewhat along the conical surface, towards the largest end thereof. This results in that the clamping ring clamps the tube only after the tube is pulled somewhat backwardly relatively to the direction of insertion. Similarly, the O-ring, when lying against the same conical surface as the clamping ring, increases its pressure against the tube after the tube is pulled somewhat backwardly. Such back-pulling forces the clamping ring and the O-ring in the direction of taper of the conical surface and, therefore, causes compression of the rings. The invention provides a coupling which resists that the clamping ring and possibly also the sealing ring are brought along by the tube being forced into the coupling.

### BRIEF EXPLANATION OF THE INVENTION

According to the invention a return ring is provided in the coupling, inside of the clamping ring in the direction of insertion of the tube or hose, said return ring engaging an inner conical surface in the coupling with a conical surface, oppositely tapered relatively to the conical surface against which the clamping ring is in engagement, and the return ring has a central aperture which is smaller than the external dimension of the tube or hose, and it is expandable, in order to be expanded and be moved along the conical surface when the tube or hose is pushed into the housing of the coupling and forced through the return ring.

During insertion of the tube the tube will be forced through the return ring and expand it. Due to the engagement against the conical surface the expansion of the return ring will force it to move along the conical surface, in the direction towards the clamping ring. Initially, the return ring may lye axially near the clamping ring. Alternatively, the sealing ring, for instance an O-ring, may be situated between the return ring and the clamping ring. In such a case it may be advantageous that a pressure ring is situated between the return ring and the O-ring, whereby the expansion of the return ring does not lead to rubbing thereof against the O-ring. The axial movement of the return ring forces the clamping ring and possibly the sealing ring in the tapering direction of the conical surface, i.e. towards the smallest part of the conical surface of the clamping ring, whereby the clamping ring and possibly the sealing ring are compressed.

In the following will, with reference to the accompanying drawing, be explained more detailed examples of embodiments of the invention.

### EXPLANATION OF THE DRAWINGS

FIG. 1 shows a longitudinal section through a coupling according to the invention, comprising a coupling housing with a throughgoing cavity, a clamping ring provided in the cavity, adapted for retaining of a tube or hose inserted in the cavity and a ring for sealing between the coupled tube or hose and the cavity, said coupling also containing a pressure ring and a return ring.

FIG. 2 shows a longitudinal section through another coupling according to the invention, comprising a coupling housing with a throughgoing cavity, a clamping ring provided in the cavity, adapted for retaining of a tube or hose inserted in the cavity and a ring for sealing between the coupled tube or hose and the cavity, said coupling also containing a return ring and a pressure ring between the return ring and the clamping ring.

FIG. 3 shows a return ring that may be included in each of the embodiments shown in the FIGS. 1 and 2, seen in a longitudinal section through the coupling, along the line A-A in FIG. 4.

FIG. 4 shows the return ring in FIG. 3, seen in a top view.

### DESCRIPTION OF EMBODIMENTS

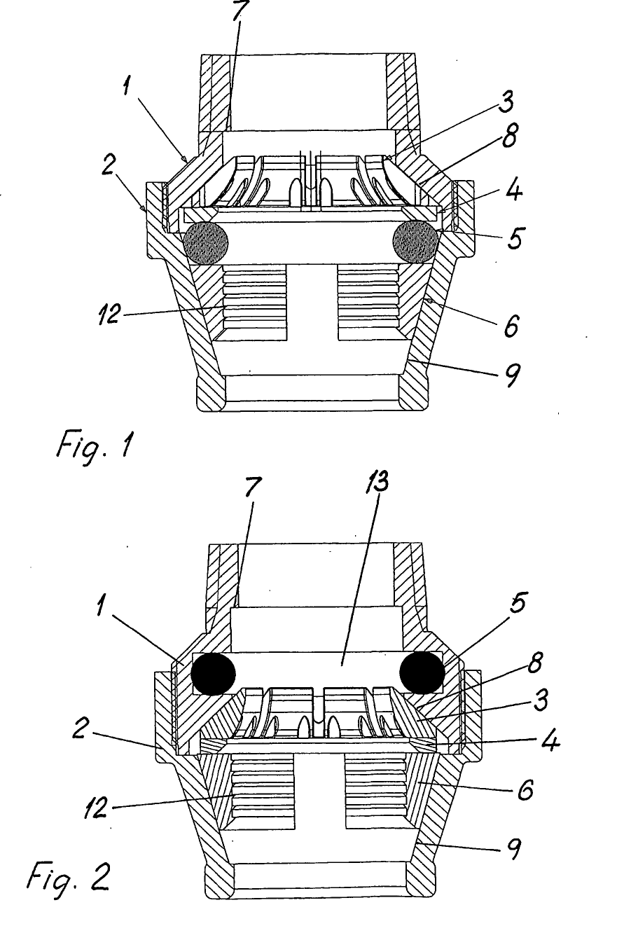

The coupling shown in FIG. 1 comprises a coupling housing, which in the example shown is composed of two housing parts 1 and 2 being screwed together. The coupling housing contains a clamping ring 6, in engagement against a conical surface 9. A sealing ring 5, shown as an O-ring, is shown in engagement with the same conical surface 9. A return ring 3 is situated axially inside of the sealing ring 5. Between the return ring 3 and the sealing ring 5 is mounted a pressure ring 4. The clamping ring 6 is shown formed with a split and with internal, circumferential edges 12 for cutting into the tube being inserted.

A not shown tube (or a hose) may be inserted into the coupling housing from the end facing downwardly on the drawing, and may be moved to end abutment against an inner step 7.

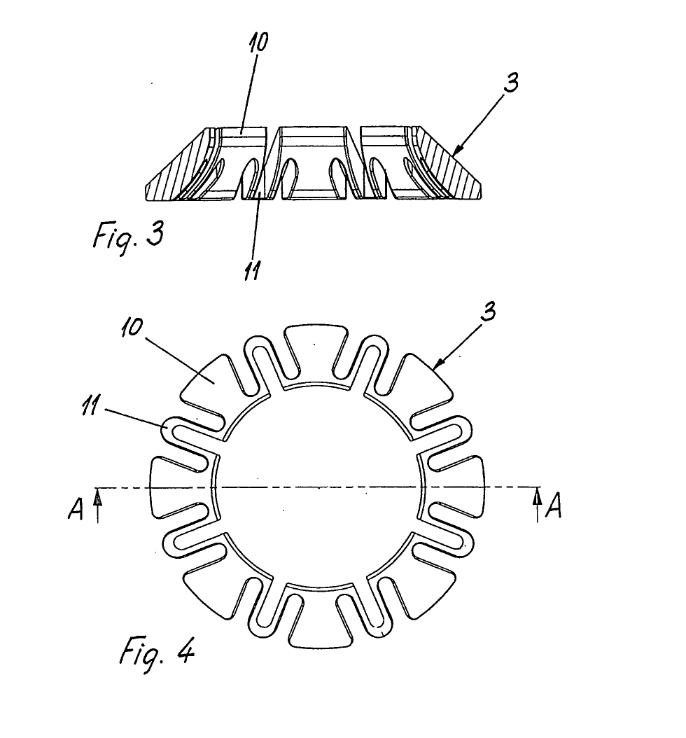

The central aperture in the return ring 3 is smaller than the tube dimension, and forcing in of the tube, therefore, will expand the return ring 3, which is formed such that it is expandable. This appears at best from FIG. 3. When the return ring is expanded, it will be forced to move along the conical surface 8, which means that it also is moved axially in the direction towards the clamping ring 6. In order to avoid that the return ring 3 rubs against the O-ring 5 in the embodiment shown in FIG. 1, the pressure ring 4 is placed therebetween, whereby the return ring 3 slides against the pressure ring 4 when being expanded.

Thus, insertion of the tube will cause, for the embodiment of FIG. 1, that the O-ring 5 and the clamping ring 6 will be subjected to a force which causes a certain movement of these rings in the direction of taper of the conical surface 9, which means that the O-ring 5 and the clamping ring 6 are compressed around the tube when the tube is forced through the return ring 3 and expands it.

FIG. 2 shows an alternative solution, which also comprises a coupling housing formed of two housing parts 1 and 2 being screwed together, with a clamping ring 6 in engagement against a conical surface 9. Here, however, the O-ring 5 is placed inside of the return ring 3, in an annular groove 13. Also here the return ring 3 is in engagement with a conical surface 8, having a taper oppositely of the conical surface 9. A pressure ring 4 is shown mounted between the return ring 3 and the clamping ring 6. The pressure ring 4 may be omitted, whereby the return ring 3 is lying directly against the clamping ring 6. Here, the O-ring 5 is not influenced by the return ring 3. The functioning of the return ring 3 is the same as for the embodiment shown in FIG. 1, except that it only influences the clamping ring 6, and not the O-ring 5.

As it appears from the FIGS. 3 and 4, the return ring 3 may be formed with a plurality of segments 10, which are mutually coupled through flexible arch portions 11 which make the return ring 3 sufficiently expandable.

The tube coupling according to the invention is particularly advantageous for coupling of plastics tubes, but may of course be used for coupling of any other tube or hose having a sufficient stiffness in order to be forced into the coupling housing. The coupling housing may be made of metal, for instance brass, or of plastics or composite material. The same applies to the clamping ring 6 and the pressure ring 4 (when included). The sealing ring 5 will normally be made of rubber or plastics, for instance neoprene, without this being mentioned as a limitation.

The return ring 3 must be able to be expanded when it is forced along the respective conical surface 8 during insertion of a tube or hose, but it may of course be shaped differently than shown.

The coupling may be adapted to be screwed onto another member, for instance a pipe, with the end being opposite of the end adapted for insertion of a tube, but the coupling housing may also be adapted for insertion of tubes from both ends. Then, the coupling may appropriately be symmetrical about a transverse central plane and contain two sets of the rings mentioned, with corresponding conical surfaces and possible annular grooves.

1. A coupling for connection of a tube or hose by pushing-in, comprising a coupling housing formed by two parts (1, 2) which are screwed together or of a single part, said coupling housing containing a clamping ring (6) and a sealing ring (5), for instance an O-ring, where at least the clamping ring is in engagement with an inner conical surface (9) in the coupling housing, characterized in that a return ring (3) is provided in the coupling, inside of the clamping ring (6) in the direction of insertion of the tube or hose, said return ring (3) engaging, with a conical surface, an inner conical surface (8) in the coupling, oppositely tapered relatively to the conical surface against which the clamping ring (6) is in engagement, and that the return ring (3) has a central aperture which is smaller than the external dimension of the tube or hose, and it is expandable, in order to be expanded and be moved along the conical surface (8) when the tube or hose is pushed into the housing of the coupling and forced through the return ring (3).

2. A coupling as defined in claim 1, in which the return ring (3) initially is situated axially near the clamping ring (6).

3. A coupling as defined in claim 1, in which the sealing ring (5) is situated between the clamping ring (6) and the return ring (3), whereby a pressure ring (4) mainly fills an axial space between the return ring and the sealing ring.

4. A coupling as defined in claim 1, in which the sealing ring (5) is situated in an annular groove (13) axially inside of the return ring (3).

5. A coupling as defined in one of the claims 1-4, in which the return ring (3) is formed with segments 10, which are successively coupled together through flexible arch portions (11).
